(19) United States
(12) Patent Application Publication
(10) Pub. No.: US 2002/0054191 A1
(43) Pub. Date: May 9, 2002

(54) Ink jet printer head and fabrication method for an ink jet printer head

(76) Inventors: Jae-Ho Moon, Suwon-city (KR); O-Keun Kwon, Suwon-city (KR)

Correspondence Address: Robert E. Bushnell, Suite 300, 1522 K Street, N.W., Washington, DC, 20005, US

(21) Appl. No.: 09/833,551

(22) Filed: Apr. 13, 2001

(30) Foreign Application Priority Data
Jul. 25, 2000 (KR) 2000/42864

(51) Int. Cl. B41J 2/05

(52) U.S. Cl. 347/56; 347/65

(57) ABSTRACT

An ink jet printer head and fabrication method for an ink jet printer head are provided. The ink jet printer head includes a silicon plate, a thin-film electrode layer, an ink chamber barrier, and a nozzle plate, which are layered in order to form the ink jet printer head. A center portion of the electrode layer is etched a predetermined depth to form a heater portion, thereby increasing electric resistance due to a decreased depth or thickness of the heater portion. Since the heater portion and electrode portions are made of a single material, the process and cost of fabrication is reduced, and productivity is increased.

This application makes reference to, incorporates the same herein, and claims all benefits accruing under 35 U.S.C. § 119 from an application entitled INK-JET PRINTER HEAD AND FABRICATION METHOD THEREOF earlier filed in the Korean Industrial Property Office on Jul. 25, 2000, and there duly assigned Serial No. 2000-42864.

### BACKGROUND OF THE INVENTION

1. Technical Field

The present invention relates to an ink jet printer head and fabrication method for an ink jet printer head and, more particularly, to an ink jet printer head having an electrode layer of an improved structure, capable of reducing a fabrication process for an ink jet printer head, so that productivity and print quality are advantageously enhanced.

2. Related Art

Generally, a thermal ink jet printer head discharges ink through a nozzle hole in such a manner that a heater resistor instantly heats the ink, generating and expanding ink bubbles.

In a related thermal ink jet printer head, a silicon plate, a thin-filmed heater resistor, an electrode layer, and an ink chamber barrier are layered in order. A center portion of the electrode layer and ink chamber barrier are etched by a photolithography process in a semiconductor manufacturing process, so that an upper surface of the thin-film heater resistor can be partially exposed to the etched portion which forms an ink chamber therein. A nozzle plate having nozzle holes is layered on the ink chamber barrier. The nozzle holes respectively communicate with an ink chamber.

According to the related ink jet printer head described above, when electric power is supplied to the electrode layer, the thin-film heater resistor instantly heats the ink in the ink chamber, generating and expanding ink bubbles. Accordingly, as the expanded ink bubbles pressure an ink chamber, the ink is discharged through a nozzle hole. Also, in the related ink jet printer head, the thin-film heater resistor is made of an alloy, such as tantalum-aluminum (Ta—Al) alloy, which typically requires a high cost sputtering for controlling the composition ratio of the tantalum-aluminum, thereby increasing the fabrication cost. Further, since the electrode layer is typically made of a metal, such as an aluminum, which is different from the heater resistor, the adhesive strength can be decreased resulting in a detachment of the layers forming the ink jet printer head.

U.S. Pat. No. 4,339,762 to Shirato et al. entitled Liquid Jet Recording Method disclose a liquid jet recording method capable of recording gradation includes filling with a liquid a conduit having, at the end, an orifice for ejecting and projecting a liquid droplet to a predetermined direction, the conduit being provided with a heat actuating portion generating a force for ejecting the liquid droplet be applying heat energy to the liquid to cause an abrupt state change. The heat actuating portion includes an electrothermal transducer having a heat generating portion such that the degree of heat supply is different from position to position on the heating surface, and controlling the strength of an input electric signal corresponding to the gradation of an image to be recorded.

U.S. Pat. No. 4,847,630 to Bhaskar et al. entitled Integrated Thermal Ink Jet Printhead And Method Of Manufacture discloses an integrated thermal ink jet printhead and manufacturing process which includes the successive build-up of an orifice plate, a first barrier layer, heater resistors, a second barrier layer, and an ink reservoir-defining layer on top of a reusable or “dummy” substrate. Lead-in conductors are formed integral with the heater resistors and openings are formed between ink reservoirs and the orifice plate to provide for ink flow under control of the heater resistors.

U.S. Pat. No. 4,882,595 to Trueba et al. entitled Hydraulically Tuned Channel Architecture discloses the use of lumped resistive elements in an ink feed channel between an ink-propelling element, such as a resistor, and an ink supply plenum. A secondary constriction in the ink feed channel is defined by a width sufficient to provide physical support for the resistive elements while avoiding resistance to ink refill. The printhead includes lead-in lobes for assisting in purging any bubbles in the ink.

U.S. Pat. No. 5,479,196 to Inada entitled Ink Jet Recording Apparatus And Method Of Recovery Ink Discharging Condition Of The Same discloses an ink jet recording apparatus that has a recording head provided with a plurality of ink discharging openings, ink paths leading to the ink discharging openings and an ink chamber commonly connected to the ink paths. Each ink path has a recording thermal energy generating element for causing film boiling of ink in the ink path so as to form a bubble of the ink vapor thereby discharging an ink droplet from the discharging opening. Tiny bubbles generated in each ink path as a result of the driving form a comparatively large void with which at least a part of the ink in each ink path is replaced so that stagnant bubbles are merged in the void and, hence, extinguished. The recording head can have an assisting thermal energy generating element which cooperates with the recording thermal energy generating element.

U.S. Pat. No. 5,760,804 to Heinzl et al. entitled Ink-Jet Printing Head For A Liquid-Jet Printing Device Operating On The Heat Converter Principle And Process For Making It disclose an ink print head of a sandwich type construction according to the bubble-jet principle. The heating elements and the shoot out openings are arranged so as to be laterally offset relative to one another in such a way that the spreading direction of the steam bubble is directed opposite to the ink shooting direction.

U.S. Pat. No. 5,850,241 to Silverbrook entitled Monolithic Print Head Structure And A Manufacturing Process Therefor Using Anisotropic Wet Etching discloses printing head which operate using coincident forces, whereby nozzles are etched through a silicon substrate, allowing two dimensional arrays of nozzles for color printing, and drive transistors, shift registers, and fault tolerance circuitry can be fabricated on the same wafer as the nozzles.

U.S. Pat. No. 5,912,685 to Raman entitled Reduced Crosstalk Ink jet Printer Printhead discloses an inkjet printhead which employs two ink feed channels to couple an ink firing chamber to the source of ink. A first one of the ink feed channels has a lower fluid resistance to ink flowing in the channel than a second one of the ink feed channels. The first ink feed channel and the second ink feed channel each have and inlet to the ink source and are arranged such that the inlet of the first ink channel is closer to the ink firing chamber than the inlet of the second ink feed channel. Adjacent ink firing chambers are arranged such that a lower fluid resistance ink channel of one ink firing chamber is next to a higher fluid resistance ink channel of a neighboring ink firing chamber.

U.S. Pat. No. 5,956,058 to Momose et al. entitled Ink Jet Print Head With Improved Space Made From Silicon Single-Crystal Substrate disclose an ink jet printer head that includes a spacer including pressure generating chambers continuous to nozzle openings, ink supply paths, and reservoirs, a cover member for covering the pressure generating chambers in a sealing fashion, and pressure generating means for generating pressure in the pressure generating chambers in accordance with print data. One of the walls of a path hole for forming a pressure generating chamber is aligned with one of the walls of a path hole for forming a reservoir. Walls defining the path hole for forming a pressure generating chamber, which are located in the vicinity of a nozzle opening, are connected to each other at an obtuse angle.

U.S. Pat. No. 6,019,457 to Silverbrook entitled Ink Jet Print Device And Print Head Or Print Apparatus Using The Same discloses an ink jet print device that includes a passageway for flowing ink having an outlet for ejecting ink at one end. The passageway has a portion where the cross-sectional dimensions of the passageway change. A generating device which generates energy for ejecting ink from the outlet is disposed on a surface intersecting the passageway and defines a part of the portion where the cross-sectional dimensions of the passageway change.

European Patent Application EP 0 652 108 A2 to Momose et al. entitled Ink Jet Print Head And A Method Of Manufacturing The Same disclose an ink jet printer head that includes a spacer including pressure generating chambers continuous to nozzle openings, ink supply paths and reservoirs, a cover member for covering the pressure generating chamber in a sealing fashion, and pressure generating means for generating pressure in the pressure generating chambers in accordance with print data. One of the walls of a path hole for forming a pressure generating chamber is aligned with one of the walls of a path hole for forming the ink supply path. Walls defining the path hole for forming a pressure generating chamber, which are located in the vicinity of a nozzle opening, are connected to each other at an obtuse angle.

### SUMMARY OF THE INVENTION

The present invention promotes overcoming the above-described problems of the related art. Therefore, it is an object, among other objects, of the present invention to provide an ink jet printer head having an electrode layer made of a single material, capable of reducing a fabrication process for an ink jet printer head, and enhancing productivity and print quality.

The above object, among other objects, of the present invention is accomplished by an ink jet printer head including a base plate, a thin-film electrode layer layered on the base plate, having a stepped recess formed in a center thereof, an ink chamber barrier layered on the thin-film electrode layer, exposing an upper surface of the stepped recess, and a nozzle plate layered on the ink chamber barrier, having nozzle hole or a plurality of nozzle holes.

The present invention also provides a fabrication method for an ink jet printer head including the steps of: layering a base plate, a thin-filmed electrode layer, and an ink chamber barrier in order; etching a center portion of the ink chamber barrier with a predetermined pattern by a photolithography process; forming a stepped recess of a predetermined depth in a center portion of the electrode layer by an etching process, such as photolithography; and layering a nozzle plate on the ink chamber barrier.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is a cross sectional plan view schematically illustrating a related ink jet printer head;

FIG. 2A is a cross sectional plan view schematically illustrating an ink jet printer head according to the present invention;

FIG. 2B is a plan view of the ink jet printer head of FIG. 2A;

FIG. 3 is a cross sectional plan view illustrating an electrode layer of the ink jet printer head of FIG. 2A; and

FIGS. 4A to 4C are cross sectional plan views illustrating a fabrication process of the ink jet printer head of FIG. 2A according to the present invention.

### DETAILED DESCRIPTION OF THE PREFERRED EMBODIMENTS

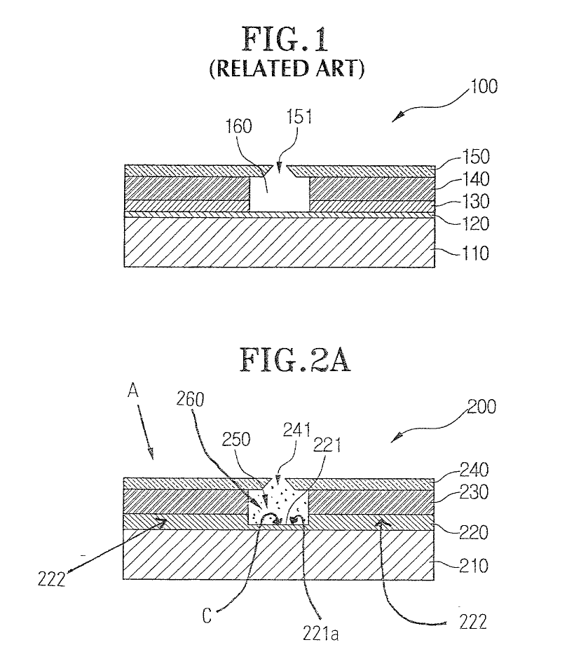

A related ink jet printer head 100 according to the present invention will now be described in detail with reference to FIG. 1 of attached drawings.

Referring now to FIG. 1, FIG. 1 is a vertical cross sectional view schematically illustrating a related thermal ink jet printer head 100. As shown in FIG. 1, a silicon plate 110, a thin-film heater resistor 120, an electrode layer 130, and an ink chamber barrier 140 are layered in order. A center portion of the electrode layer 130 and ink chamber barrier 140 are etched by a photolithography process in a semiconductor manufacturing process, so that an upper surface of the thin-film heater resistor 120 can be partially exposed to the etched portion which forms an ink chamber 160 therein. A nozzle plate 150 having a plurality of nozzle holes 151 is layered on the ink chamber barrier 140. The nozzle holes 151 communicate with an ink chamber 160.

According to the related ink jet printer head 100 constructed as described above, when electric power is supplied to the electrode layer 130, the thin-film heater resistor 120 instantly heats the ink in the ink chamber 160, generating and expanding ink bubbles. Accordingly, as the expanded ink bubbles pressure an ink chamber 160, the ink is discharged through a nozzle hole or holes 151.

Also, in the related ink jet printer head 100 of FIG. 1, the heater resistor 120 is made of an alloy, such as a tantalum-aluminum (Ta—Al), which typically requires a high price sputtering process for controlling the composition ratio of the tantalum-aluminum, thereby typically increasing the fabrication cost for the ink jet printer head 100. Further, since the electrode layer 130 is made of a metal, such as an aluminum, which is different from the composition of the thin-film heater resistor 120, the adhesive strength of the layers of the jet printer head 100 is typically decreased which can result in a detachment of the layers.

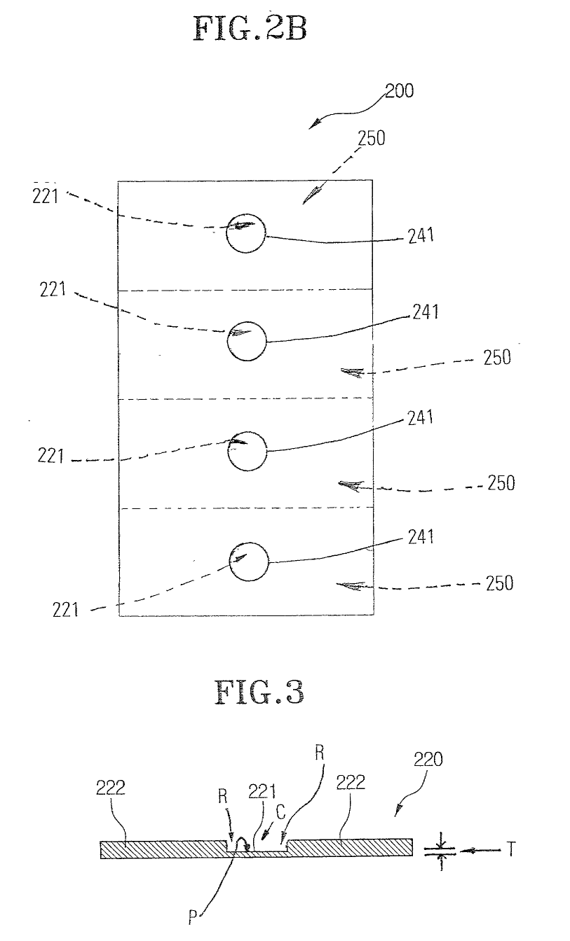

An ink jet printer head 200 according to the present invention will now be described in detail with reference to the attached drawings, particularly FIGS. 2A through 4C. Referring now to FIGS. 2A, 2B and 3, the ink jet printer head 200 according to the resent invention is illustrated. The ink jet printer head 200 includes a silicon plate 210, a thin-film electrode layer 220, an ink chamber barrier 230 and a nozzle plate 240, which are layered in that order, as illustrated in FIG. 2A. A heater portion 221 having a stepped recess R is formed in a center portion C of the thin-film electrode layer 220. A plurality of electrode portions 222 are formed at opposing sides of a corresponding heater portion 221. An ink chamber 250 is defined in a manner that a center of a corresponding ink chamber barrier 230, corresponding to the center C of an electrode layer 220, is etched, partially exposing an upper surface of a corresponding heater portion 221 to the etched portion of the corresponding ink chamber barrier 230, this upper surface being further etched to provide the stepped recess R forming a corresponding heater portion 221. The nozzle plate 240 has at least one nozzle hole or opening 241 or has a plurality of nozzle holes or openings 241 which respectively communicate with a corresponding ink chamber 250, as illustrated in FIGS. 2A and 2B, with FIG. 2B being a plan view of the ink jet printer head 200 of FIG. 2A in the direction of the arrow A.

According to the present invention, in the ink jet printer head 200 of FIGS. 2A, 2B and 3, the heater portion 221 and the electrode portions 222 of the electrode layer 220 are made of an acid resistant metal, such as a nickel (Ni), for example, and are layered in the ink jet printer head 200 by sputtering, photolithography and plating processes. Also, a pattern P and a thickness T of each heater portion 221 can be adjusted in the layering process. In this regard, as a thickness T of the heater portion 221 is decreased, electric resistance increases, and heat is generated from a corresponding heater portion 221.

According to the ink jet printer head 200 of the present invention as described above, as electric power is supplied to the electrode portions 222 of an electrode layer 220, heat is generated from a corresponding heater portion 221 by the electric resistance, and the corresponding heater portion 221 instantly heats ink 260 in a corresponding ink chamber 250, thereby generating and expanding ink bubbles of the ink 260. Accordingly, as the ink bubbles pressure a corresponding ink chamber 250, the ink 260 is discharged through a corresponding nozzle hole or opening 241.

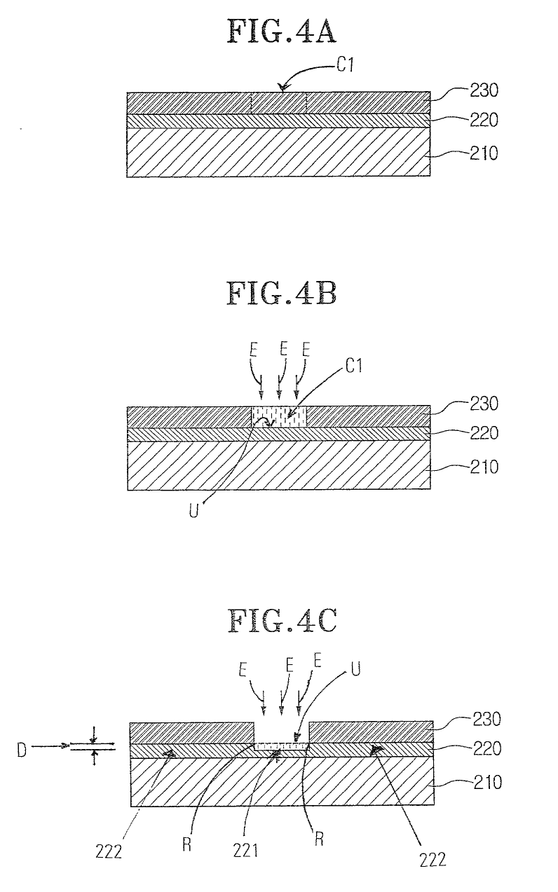

Referring now to FIGS. 4A to 4C, a fabrication method of the ink jet printer head 200 of FIGS. 2A, 2B and 3 according to the present invention will be described as follows.

First, as illustrated in FIG. 4A, a thin-film electrode layer 220 made of an acid resistant metal, such as a nickel, to form a thin-film coated nickel layer as a thin-film electrode layer 220, for example, is layered on a silicon plate 210 by a sputtering process. Then, an ink chamber barrier 230 is layered on the electrode layer 220. The ink chamber barrier 230 is formed of a suitable material that can be etched, such as a silicon dioxide material. Next, as illustrated in FIG. 4B, a center portion C1 of the ink chamber barrier 230 is etched, with or to form a predetermined pattern, by a photolithography process indicated by the arrows E to partially expose an upper surface U of the thin-film electrode layer 220. Then, as illustrated in FIG. 4C, the exposed surface U of the thin-film electrode layer 220 is further etched to a predetermined depth. D to provide a stepped recess R (FIG. 3) forming a corresponding heater portion 221 having a thickness T (FIG. 3), as well as to provide a surface 221a of the corresponding heater portion 220, the stepped recess R communicating with the etched portion of the corresponding ink chamber barrier 230 to provide a corresponding ink chamber 250. Lastly, a nozzle plate 240 having a nozzle hole or opening 241 or having a plurality of nozzle holes or openings 241 (FIGS. 2A and 2B) is layered on each corresponding ink chamber barrier 230, and the fabrication process of the ink jet printer head 200 is then completed. The nozzle plate 240 is formed of a suitable material, such as a suitable metal, plastic or silicon material, for example.

According to the present invention, since a thickness T (FIG. 3) of a heater portion 221 can be adjusted, the degree of heating of a corresponding heater portion 221 and the degree of the heating of ink 260 by a corresponding heater portion 221 can be controlled, thereby enhancing the print quality. Also, since a heater portion 221 and the electrode portions 222 are typically made of a single material or of a same material, such as nickel (Ni), for example, the process and cost of fabrication of an ink jet printer head according to the present invention can be reduced, and productivity can thereby be increased. Also, when a heater portion 221 and corresponding electrode portions 222 are made of the same material, a detachment of the electrode layer 220 in the ink jet printer head 200 can be prevented, such detachment of an electrode layer typically being caused by a lack of adhesive strength when a heater portion and electrode portions are made of different materials.

While there have been illustrated and described what are considered to be preferred embodiments of the present invention, it will be understood by those skilled in the art that various changes and modifications may be made, and equivalents may be substituted for elements thereof without departing from the true scope of the present invention. In addition, many modifications may be made to adapt a particular situation to the teaching of the present invention without departing from the scope thereof. Therefore, it is intended that the present invention not be limited to the particular embodiments disclosed as the best mode contemplated for carrying out the present invention, but that the present invention includes all embodiments falling within the scope of the appended claims.

What is claimed is:

1. An ink jet printer head, comprising:
a base plate;
a thin-film electrode layer layered on the base plate, the thin-film electrode layer having a stepped recess formed in thin-film electrode layer, the stepped recess forming a heater portion for heating ink;
an ink chamber barrier layered on the electrode layer, the ink chamber barrier being formed in communication with the stepped recess forming the heater portion to provide an ink chamber for receiving the ink; and
a nozzle plate layered on the ink chamber barrier, the nozzle plate having a nozzle opening communicating with the ink chamber for discharging the ink.

2. The ink jet printer head as claimed in claim 1, further comprised of the thin-film electrode layer being a thin film coated nickel layer.

3. The ink jet printer head as claimed in claim 2, further comprised of the base plate being a silicon plate.

4. The ink jet printer head as claimed in claim 3, further comprised of the stepped recess forming the heater portion being formed in a center of the thin-film electrode layer.

5. The ink jet printer head as claimed in claim 1, further comprised of the thin-film electrode layer being formed of an acid resistant metal.

6. The ink jet printer head as claimed in claim 1, further comprised of the stepped recess forming the heater portion being formed in a center of the thin-film electrode layer.

7. The ink jet printer head as claimed in claim 6, further comprised of the thin-film electrode layer being a thin film coated nickel layer.

8. The ink jet printer head as claimed in claim 1, further comprised of the thin-film electrode layer including a plurality of electrode portions formed at opposing sides of the heater portion of the thin-film electrode layer for generating heat by the heater portion to heat the ink in the ink chamber.

9. The ink jet printer head as claimed in claim 8, further comprised of the plurality of electrode portions and the heater portion of the thin-film electrode layer being formed of a same material.

10. The ink jet printer head as claimed in claim 9, further comprised of the thin-film electrode layer being a thin filmed coated nickel layer.

11. The ink jet printer head as claimed in claim 10, further comprised of the base plate being a silicon plate.

12. The ink jet printer head as claimed in claim 10, further comprised of the stepped recess forming the heater portion being formed in a center of the thin-film electrode layer.

13. The ink jet printer head as claimed in claim 1, further comprised of the nozzle plate having a plurality of nozzle openings, each nozzle opening communicating with a corresponding ink chamber for discharging ink through a corresponding nozzle opening of the plurality of nozzle openings, with each ink chamber having a corresponding ink chamber barrier and having a corresponding heater portion, each corresponding heater portion having a corresponding stepped recess formed in a corresponding thin-film electrode layer for heating ink.

14. The ink jet printer head as claimed in claim 13, further comprised of each corresponding thin-film electrode layer being a thin film coated nickel layer.

15. The ink jet printer head as claimed in claim 14, further comprised of the base plate being a silicon plate.

16. The ink jet printer head as claimed in claim 15, further comprised of a corresponding stepped recess forming a corresponding heater portion being formed in a center of a corresponding thin-film electrode layer.

17. The ink jet printer head as claimed in claim 13, further comprised of each corresponding thin-film electrode layer being formed of an acid resistant metal.

18. The ink jet printer head as claimed in claim 13, further comprised of a corresponding stepped recess forming a corresponding heater portion being formed in a center of a corresponding thin-film electrode layer.

19. The ink jet printer head as claimed in claim 18, further comprised of each corresponding thin-film electrode layer being a thin film coated nickel layer.

20. The ink jet printer head as claimed in claim 13, further comprised of each corresponding thin-film electrode layer including a plurality of electrode portions formed at opposing sides of a corresponding heater portion of a corresponding thin-film electrode layer for generating heat by the corresponding heater portion to heat the ink in a corresponding ink chamber.

21. The ink jet printer head as claimed in claim 20, further comprised of the plurality of electrode portions and the corresponding heater portion of the corresponding thin-film electrode layer being formed of a same material.

22. The ink jet printer head as claimed in claim 21, further comprised of the corresponding thin-film electrode layer being a thin film coated nickel layer.

23. The ink jet printer head as claimed in claim 22, further comprised of the base plate being a silicon plate.

24. The ink jet printer head as claimed in claim 22, further comprised of a corresponding stepped recess forming the corresponding heater portion being formed in a center of the corresponding thin-film electrode layer.

25. A fabrication method for an ink jet printer head, comprising the steps of:
layering a base plate;
layering a thin-film electrode layer on the base plate;
layering an ink chamber barrier on the thin-film electrode layer;
etching a portion of the ink chamber barrier so as to provide a portion of an ink chamber for receiving ink;
forming by an etching process a stepped recess of a predetermined depth in a portion of the thin-film electrode layer to provide a portion of the ink chamber and to provide a heater portion for heating ink in the ink chamber; and
layering a nozzle plate including a nozzle opening on the ink chamber barrier, the nozzle opening communicating with the ink chamber for discharging ink.

26. The method as claimed in claim 25, further comprised of the step of etching a portion of the ink chamber barrier including etching a center portion of the ink chamber barrier and the step of forming by an etching process a stepped recess including etching a center portion of the thin-film electrode layer.

27. The method as claimed in claim 26, further comprised of the step of etching a portion of the ink chamber barrier including etching the ink chamber barrier to have a predetermined pattern and the step of forming by an etching process a stepped recess including forming the heater portion to have a predetermined pattern.

28. The method as claimed in claim 25, further comprised of the nozzle plate including a plurality of nozzle openings for discharging ink, the step of etching a portion of the ink chamber barrier including etching a corresponding portion of a corresponding ink chamber barrier to provide a portion of a corresponding ink chamber for a corresponding nozzle opening of the plurality of nozzle openings, and the step of forming by an etching process a stepped recess including forming by an etching process a corresponding stepped recess of a predetermined depth in a corresponding portion of a corresponding thin-film electrode layer to provide a portion of a corresponding ink chamber and to provide a corresponding heater portion for heating ink in a corresponding ink chamber, each corresponding ink chamber being formed so as to correspond to a corresponding nozzle opening of the plurality of nozzle openings for discharging ink from a corresponding nozzle opening.

29. The method as claimed in claim 28, further comprised of etching a corresponding portion of a corresponding ink chamber barrier including etching a center portion of a corresponding ink chamber barrier to provide a portion of a corresponding ink chamber, and forming by an etching process a corresponding stepped recess including forming by an etching process a corresponding stepped recess of a predetermined depth in a center portion of a corresponding thin-film electrode layer to provide a corresponding heater portion for heating ink in a corresponding ink chamber.

30. The method as claimed in claim 29, further comprised of etching a corresponding portion of a corresponding ink chamber barrier including etching the corresponding ink chamber barrier to provide a predetermined pattern for the corresponding ink chamber.

31. The method as claimed in claim 28, further comprised of layering a corresponding thin-film electrode layer to form a corresponding thin-film electrode layer as a thin film coated nickel layer.

32. The method as claimed in claim 25, further comprised of the step of layering a thin-film electrode layer including forming the thin-film electrode layer as a thin film coated nickel layer.
